(19) United States
(12) Patent Application Publication
(10) Pub. No.: US 2025/0285184 A1
(43) Pub. Date: Sep. 11, 2025

(54) SYSTEMS AND METHODS FOR PERFORMING A VALUE ANALYSIS AND DISPLAYING A CORRESPONDING MODEL

(71) Applicant: Yahoo Assets LLC, New York, NY (US)

(72) Inventors: Eric BAX, Sierra Madre, CA (US); Ran MOSHE, Yaakov (IL); Dipen RUGHWANI, Cupertino, CA (US)

(21) Appl. No.: 18/596,015

(22) Filed: Mar. 5, 2024

(51) Int. Cl. G06Q 40/06

(52) U.S. Cl. CPC G06Q 40/06

(57) ABSTRACT

Systems and methods are disclosed for providing a value analysis. One method comprises receiving an original set of one or more records, an exchange portion of the original set, a selected record set of one or more selected records, a time period, and an interval length from a user, computing original set data of the original set, determining base set data for a base set for the interval length over the time period, comparing the original set and the base set to determine an exchange value, determining an updated exchange value for the selected record set, updating the base set and the base set data to include the selected record set and the updated exchange value, and displaying at least one model of the original set data and the updated base set data for each selected record of the selected record set on a user interface of the user device.

### TECHNICAL FIELD

The present disclosure relates generally to providing a performance analysis of candidate investments based on historical data and, more particularly, to systems and methods for providing and displaying a performance analysis of candidate investments.

### BACKGROUND

Individual investors often search for investments to add to their portfolios. In many cases, an individual investor may select some candidate investments, or a class of candidate investments (e.g., any stock in the S&P 500), to add to the investor's portfolio. In many situations, the investor may want to utilize historical data to evaluate how adding a candidate investment to the investor's portfolio in the past would have altered the portfolio's returns over time. For example, the investor may want to know how the candidate investment would have added to the portfolio returns, and also whether the candidate investment would have smoothed out returns over time.

Conventional methods may allow the investor to see the price history for each candidate on different time scales, as well as allow the investor to see the numbers that indicate the returns and volatility for each candidate. However, such information alone may make it difficult for the investor to evaluate the historical price series and statistics for returns and volatility for portfolios that combine the investor's portfolio with each candidate investment. As a result, investors may desire for a personalized system to automatically assemble, analyze, and display price histories for candidate investments combined with the investor's portfolio.

This disclosure is directed to addressing above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

Embodiments of the present disclosure include systems and methods for providing a value analysis of candidate investments based on historical data.

According to certain embodiments, computer-implemented methods are disclosed for providing a value analysis. One method may include receiving, by one or more processors, an original set of one or more records, an exchange portion of the original set, a selected record set of one or more selected records, a time period, and an interval length from a user via a user device. The method may include computing, by the one or more processors, original set data of the original set, wherein the original set data includes a value for each of the one or more records for the interval length over the time period. The method may include determining, by the one or more processors, base set data for a base set of the one or more records for the interval length over the time period, wherein the base set includes the original set without the exchange portion. The method may include comparing, by the one or more processors, the original set and the base set to determine an exchange value. The method may include determining, by the one or more processors, an updated exchange value for the selected record set for the interval length over the time period. The method may include updating, by the one or more processors, the base set and the base set data to include the selected record set and the updated exchange value. The method may include displaying, by the one or more processors, at least one model of the original set data and the updated base set data for each selected record of the selected record set on a user interface of the user device.

According to certain embodiments, a computer system for providing a value analysis is disclosed. The computer system may comprise a memory having processor-readable instructions stored therein, and one or more processors configured to access the memory and execute the processor-readable instructions, which when executed by the one or more processors configures the one or more processors to perform a plurality of functions. The functions may include receiving an original set of one or more records, an exchange portion of the original set, a selected record set of one or more selected records, a time period, and an interval length from a user via a user device. The functions may include computing original set data of the original set, wherein the original set data includes a value for each of the one or more records for the interval length over the time period. The functions may include determining base set data for a base set of the one or more records for the interval length over the time period, wherein the base set includes the original set without the exchange portion. The functions may include comparing the original set and the base set to determine an exchange value. The functions may include determining an updated exchange value for the selected record set for the interval length over the time period. The functions may include updating the base set and the base set data to include the selected record set and the updated exchange value. The functions may include displaying at least one model of the original set data and the updated base set data for each selected record of the selected record set on a user interface of the user device.

According to certain embodiments, a non-transitory computer-readable medium containing instructions for providing a value analysis is disclosed. The instructions may include receiving an original set of one or more records, an exchange portion of the original set, a selected record set of one or more selected records, a time period, and an interval length from a user via a user device. The instructions may include computing original set data of the original set, wherein the original set data includes a value for each of the one or more records for the interval length over the time period. The instructions may include determining base set data for a base set of the one or more records for the interval length over the time period, wherein the base set includes the original set without the exchange portion. The instructions may include comparing the original set and the base set to determine an exchange value. The instructions may include determining an updated exchange value for the selected record set for the interval length over the time period. The instructions may include updating the base set and the base set data to include the selected record set and the updated exchange value. The instructions may include displaying at least one model of the original set data and the updated base set data for each selected record of the selected record set on a user interface of the user device.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts a schematic diagram illustrating an example environment implementing methods and systems of this disclosure, according to one or more embodiments.

FIG. 2 depicts a flow diagram of an exemplary method for a value analysis of candidate investments based on historical data, according to one or more embodiments.

FIG. 3 depicts an exemplary model that illustrates a candidate portfolio's monthly values, according to one or more embodiments.

FIG. 4 depicts an exemplary model that illustrates an analysis of a candidate portfolio's gains and volatility, according to one or more embodiments.

FIG. 5 depicts an exemplary model that illustrates an analysis of a candidate portfolio's gains, volatility, and Sharpe ratio, according to one or more embodiments.

FIG. 6 depicts an example system that may execute techniques presented herein.

### DETAILED DESCRIPTION OF EMBODIMENTS

According to certain aspects of the disclosure, methods and systems are disclosed for providing and displaying a value analysis of candidate investments based on historical data. Conventional techniques may not be suitable at least because conventional techniques, among other things, are unable to provide a personalized analysis that is specific towards the user's investment portfolio. Accordingly, improvements in technology relating to the process of analyzing a user's investment portfolio based on historical data of a candidate investment are needed.

Individual investors often search for investments to add to their portfolios. In many cases, an individual investor may select some candidate investments, or a class of candidate investments (e.g., any stock in the S&P 500), to add to the investor's portfolio. In many situations, the investor may want to utilize historical data to evaluate how adding a candidate investment to the investor's portfolio in the past would have altered the portfolio's returns over time. For example, the investor may want to know how the candidate investment would have added to the portfolio returns, and also whether the candidate investment would have smoothed out returns over time.

Conventional methods may allow the investor to see the price history for each candidate on different time scales, as well as allow the investor to see the numbers that indicate the returns and volatility for each candidate. However, such information alone may make it difficult for the investor to evaluate the historical price series and statistics for returns and volatility for portfolios that combine the investor's portfolio with each candidate investment. As a result, investors may desire for a personalized system to automatically assemble, analyze, and display price histories for candidate investments combined with the investor's portfolio.

This disclosure provides systems and methods for providing a value analysis. The systems and methods may include receiving, by one or more processors, an original set of one or more records, an exchange portion of the original set, a selected record set of one or more selected records, a time period, and an interval length from a user via a user device. The systems and methods may include computing, by the one or more processors, original set data of the original set, wherein the original set data includes a value for each of the one or more records for the interval length over the time period. The systems and method may include determining, by the one or more processors, base set data for a base set of the one or more records for the interval length over the time period, wherein the base set includes the original set without the exchange portion. The systems and methods may include comparing, by the one or more processors, the original set and the base set to determine an exchange value. The systems and methods may include determining, by the one or more processors, an updated exchange value for the selected record set for the interval length over the time period. The systems and methods may include updating, by the one or more processors, the base set and the base set data to include the selected record set and the updated exchange value. The systems and methods may include displaying, by the one or more processors, at least one model of the original set data and the updated base set data for each selected record of the selected record set on a user interface of the user device.

Advantages of such a system may include increasing the efficiency of analyzing investment portfolios with potential candidate investments. For example, the amount of historical data for investments is vast, and analyzing such data by hand may lead to inefficiencies and errors. Additionally, users may desire the ability to analyze such historical data quickly and accurately. Additional advantages may include efficiently and accurately creating and outputting models that reflect the analysis of the historical data of both the investment portfolios and the potential candidate investments. Additional advantages may include allowing users to update analysis data and/or interact with the models to further refine the analysis of the investment portfolios and the potential candidate investments.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

As used herein, the terms “comprises,” “comprising,” “having,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, relative terms, such as, for example, “about,” “substantially,” “generally,” and “approximately” are used to indicate a possible variation of +10% in a stated value. The term “exemplary” is used in the sense of “example” rather than “ideal.” As used herein, the singular forms “a,” “an,” and “the” include plural reference unless the context dictates otherwise

### Exemplary Environment

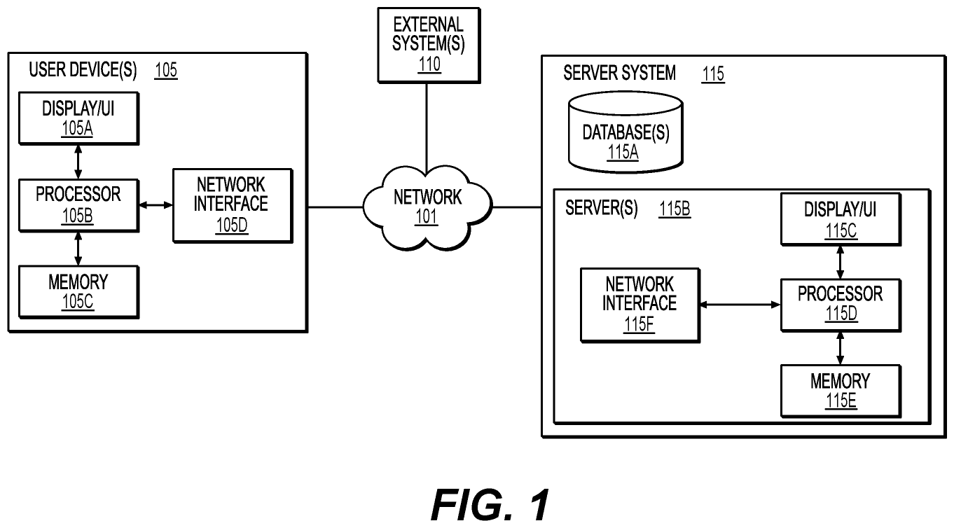

FIG. 1 depicts an exemplary environment 100 that may be utilized with the techniques presented herein. One or more user device(s) 105, one or more external system(s) 110, and one or more server system(s) 115 may communicate across a network 101. As will be discussed in further detail below, one or more server system(s) 115 may communicate with one or more of the other components of the environment 100 across network 101. The one or more user device(s) 105 may be associated with a user.

In some embodiments, the components of the environment 100 are associated with a common entity. In some embodiments, one or more of the components of the environment is associated with a different entity than another. The systems and devices of the environment 100 may communicate in any arrangement.

The user device 105 may be configured to enable the user to access and/or interact with other systems in the environment 100. For example, the user device 105 may be a computer system such as, for example, a desktop computer, a mobile device, a tablet, etc. In some embodiments, the user device 105 may include one or more electronic application(s), e.g., a program, plugin, browser extension, etc., installed on a memory of the user device 105.

The user device 105 may include a display/user interface (UI) 105A, a processor 105B, a memory 105C, and/or a network interface 105D. The user device 105 may execute, by the processor 105B, an operating system (O/S) and at least one electronic application (each stored in memory 105C). The electronic application may be a desktop program, a browser program, a web client, or a mobile application program (which may also be a browser program in a mobile O/S), an applicant specific program, system control software, system monitoring software, software development tools, or the like. For example, environment 100 may extend information on a web client that may be accessed through a web browser. In some embodiments, the electronic application(s) may be associated with one or more of the other components in the environment 100. The application may manage the memory 105C, such as a database, to transmit streaming data to network 101. The display/UI 105A may be a touch screen or a display with other input systems (e.g., mouse, keyboard, etc.) so that the user(s) may interact with the application and/or the O/S. The network interface 105D may be a TCP/IP network interface for, e.g., Ethernet or wireless communications with the network 101. The processor 105B, while executing the application, may generate data and/or receive user inputs from the display/UI 105A and/or receive/transmit messages to the server system 115, and may further perform one or more operations prior to providing an output to the network 101.

External systems 110 may be, for example, one or more third party and/or auxiliary systems that integrate and/or communicate with the server system 115 in performing various investment portfolio analysis tasks. For example, external systems 110 may include third party systems that store investment information, such as stock information, bond information, currency information, crypto information, and the like. External systems 110 may be in communication with other device(s) or system(s) in the environment 100 over the one or more networks 101. For example, external systems 110 may communicate with the server system 115 via API (application programming interface) access over the one or more networks 101, and also communicate with the user device(s) 105 via web browser access over the one or more networks 101.

In various embodiments, the network 101 may be a wide area network (“WAN”), a local area network (“LAN”), a personal area network (“PAN”), or the like. In some embodiments, network 101 includes the Internet, and information and data provided between various systems occurs online. “Online” may mean connecting to or accessing source data or information from a location remote from other devices or networks coupled to the Internet. Alternatively, “online” may refer to connecting or accessing a network (wired or wireless) via a mobile communications network or device. The Internet is a worldwide system of computer networks—a network of networks in which a party at one computer or other device connected to the network can obtain information from any other computer and communicate with parties of other computers or devices. The most widely used part of the Internet is the World Wide Web (often-abbreviated “WWW” or called “the Web”). A “website page” generally encompasses a location, data store, or the like that is, for example, hosted and/or operated by a computer system so as to be accessible online, and that may include data configured to cause a program such as a web browser to perform operations such as send, receive, or process data, generate a visual display and/or an interactive interface, or the like.

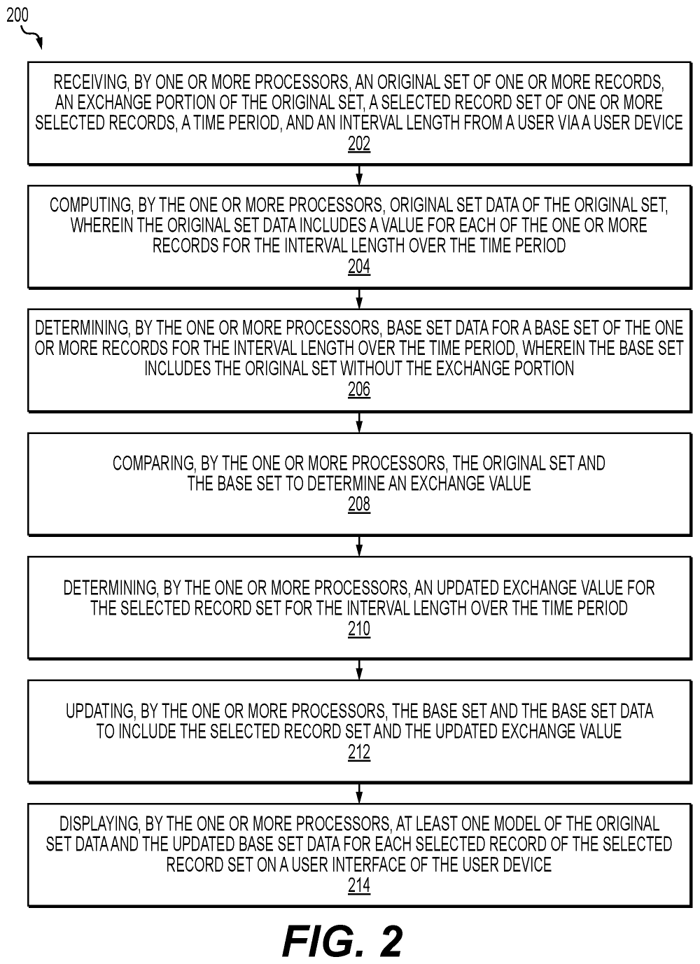

The server system 115 may include an electronic data system, e.g., a computer-readable memory such as a hard drive, flash drive, disk, etc. In some embodiments, the server system 115 includes and/or interacts with an application programming interface for exchanging data to other systems, e.g., one or more of the other components of the environment. In some embodiments, the server system 115 may correspond to a computing subsystem that may perform one or more of the operations described in relation to FIG. 2.

The server system 115 may include a database 115A and at least one server 115B. The server system 115 may be a computer, system of computers (e.g., rack server(s)), and/or or a cloud service computer system. The server system may store or have access to database 115A (e.g., hosted on a third party server or in memory 115E). For example, database 115A may store price histories, payouts (including dividends) and stock splits for one or more investments. Additionally, or alternatively, database 115A may store one or more investment portfolios for one or more users, including the investment portfolio information described below. The database 115A may store the investment portfolio with a portfolio identifier to easily retrieve the investment portfolio. Database 115A may include one or more records, where each of the records correspond to an investment of an investment profile and/or an investment of an investment offering (e.g., S&P 500). The server(s) may include a display/UI 115C, a processor 115D, a memory 115E, and/or a network interface 115F. The display/UI 115C may be a touch screen or a display with other input systems (e.g., mouse, keyboard, etc.) for an operator of the server 115B to control the functions of the server 115B. The server system 115 may execute, by the processor 115D, an operating system (O/S) and at least one instance of a servlet program (each stored in memory 115E).

In the methods below, various acts may be described as performed or executed by a component from FIG. 1, such as the server system 115, the user device 105, or components thereof. However, it should be understood that in various embodiments, various components of the environment 100 discussed above may execute instructions or perform acts including the acts discussed above and below. An act performed by a device may be considered to be performed by a processor, actuator, or the like associated with that device. Further, it should be understood that in various embodiments, various steps may be added, omitted, and/or rearranged in any suitable manner.

In general, any process or operation discussed in this disclosure that is understood to be computer-implementable, such as the processes illustrated in FIG. 2, may be performed by one or more processors of a computer system, such any of the systems or devices in the environment 100 of FIG. 1, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process or operation in the examples above, may include one or more computing devices, such as one or more of the systems or devices in FIG. 1. One or more processors of a computer system may be included in a single computing device or distributed among a plurality of computing devices. A memory of the computer system may include the respective memory of each computing device of the plurality of computing devices.

Although depicted as separate components in FIG. 1, it should be understood that a component or portion of a component in the environment 100 may, in some embodiments, be integrated with or incorporated into one or more other components. For example, a portion of the display 115C may be integrated into the user device 105 or the like. In some embodiments, operations or aspects of one or more of the components discussed above may be distributed amongst one or more other components. Any suitable arrangement and/or integration of the various systems and devices of the environment 100 may be used.

### Exemplary Method for Performing a Value Analysis

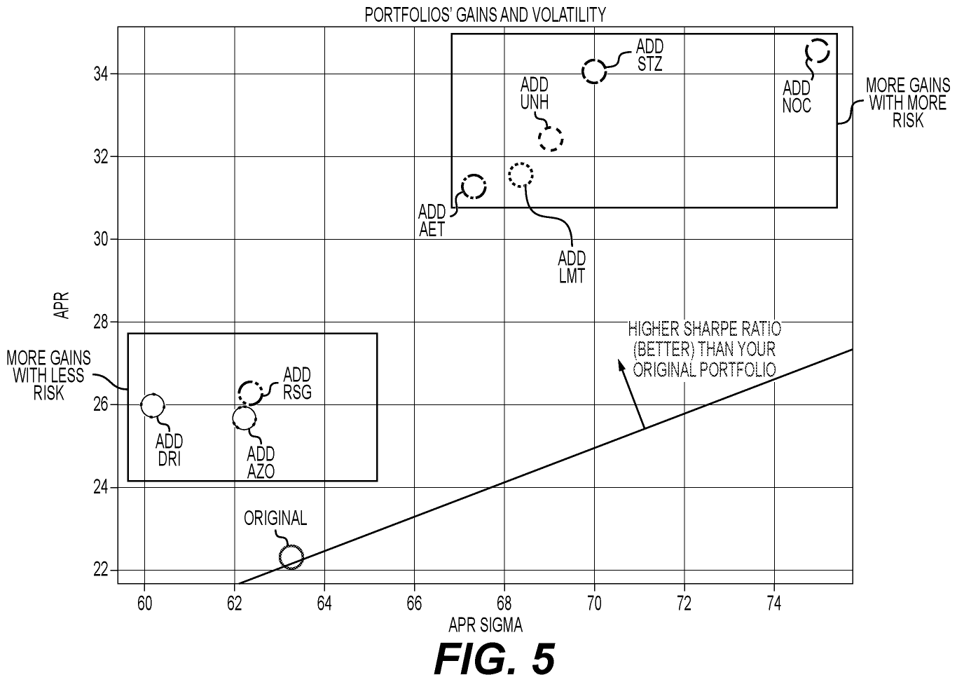

FIG. 2 depicts a flow diagram of an exemplary method 200 providing a value analysis, according to one or more embodiments. Notably, method 200 may be performed by one or more processors of a server that is in communication with one or more user devices and other external system(s) via a network. However, it should be noted that method 200 may be performed by any one or more of the server, one or more user devices, or other external systems. Exemplary method 200 may be executed on one or more components of FIG. 1 or 5.

The method may include receiving, by one or more processors, an original set of one or more records (e.g., an investment portfolio), an exchange portion of the original set, a selected record set of one or more selected records (e.g., selected investments/candidate investments), a time period, and an interval length from a user via a user device (e.g., user device(s) 105) (Step 202). The original set of one or more records may correspond to an investment portfolio of one or more investments. For example, the one or more records may include stocks, bonds, cash, and the like. The investment portfolio may include the one or more records, where each record may correspond to an investment. The original set data (e.g., investment portfolio information) of one or more records (e.g., the investment portfolio) may include a unique record identifier, a record amount, an investment description, and/or an investment date for each of the one or more records (e.g., each investment corresponding to each record). For example, the unique record identifier may be used to identify the particular investment holding. The record amount may correspond to the amount of the particular investment that is included in the investment portfolio. For example, the record amount may include a dollar amount, a stock amount, a bond amount, and the like. The investment description may correspond to a description of the particular investment. The investment date may correspond to a date that the investment was acquired. In some embodiments, one or more databases may store the one or more records (e.g., database 115A).

The exchange portion of the original set may correspond to the portion of the investment portfolio (e.g., one or more stocks, cash, one or more bonds, and the like) that the user may want to consider exchanging for another investment. For example, the user may specify (e.g., via display 105A and/or display 115A) that the user wants to exchange $10,000 of cash of the investment portfolio for another investment. As another example, the user may specify that the user wants to exchange 200 shares of stock in some company for another investment.

The selected record set may correspond to a set of candidate investments that the user may wish to substitute the exchange portion. The candidate investments may include one or more stocks (e.g., stocks in different indices), one or more bonds (e.g., bonds with different ratings), a cash amount, cryptocurrency, and the like. In some embodiments, the candidate investments may correspond to investments by sector (e.g., automotive, entertainment, etc.) and/or company size. For example, the candidate investment may correspond to stocks in a midsize technology company.

In some embodiments, the user may wish for the system to analyze each of the candidate investments separately with respect to the rest of the portfolio. Additionally, or alternatively, the user may wish for the system (e.g., server system 115) to analyze two or more candidate investments together, with respect to the rest of the portfolio. In such situations, the selected record set may also include a ratio that may indicate the amount of the exchange portion that should be substituted with the candidate investment. For example, the selected record set may include the following input: technology company, 30%; and oil company, 70%. The input may indicate that 30% of the exchange portion should be comprised of the technology company, and 70% of the exchange portion should be comprised of the oil company.

The time period may correspond to a period of time, such as a day, month, year, and the like. In some embodiments, the time period may include a default time period. For example, the default time period may correspond to a pre-set time period. The interval length may correspond to an interval of the time period. For example, the time period may be for six months, where the interval may be for 24 hours. In some embodiments, the interval length may include a default interval length. For example, the default interval length may correspond to a pre-set interval length.

One or more data stores (e.g., database 115A) may store the investment portfolio, where the one or more data stores may be a part of one or more external systems (e.g., external system(s) 110) and/or one or more internal systems (e.g., server system 115).

The exchange portion of the original set (e.g., investment portfolio) may correspond to a portion of the investment portfolio that the user wants to consider exchanging for another investment. For example, a user may have an investment portfolio that includes 1,000 stocks in 3 different companies for a total of 3,000 stocks. The user may select 100 stocks from each of the 3 companies as the exchange portion. The selected record set may correspond to one or more investments, such as stocks, bonds, cash, cryptocurrency, and the like. The selected record set may include a default set of selected records, where the system (e.g., server system 115) may have previously determined the selected records. For example, the selected records may have been pre-set by the system. Additionally, or alternatively, the method may include analyzing the investment portfolio (with or without the exchange portion described below) to determine the selected records, where the selected records may be similar to the investments in the investment portfolio. For example, the system may analyze the investment portfolio to determine that the investment portfolio focuses on entertainment companies and oil companies. The system may then determine other entertainment companies and oil companies that may be good candidate investments for the user. In some embodiments, the system may use one or more machine-learning models to determine recommended candidate investments for the user.

The user may input (e.g., via display 105A and/or display 115A) some or all of the investment portfolio, the exchange portion, the selected investments (e.g., candidate investments), the time period, and/or the interval length. For example, the user may input the information via a user device (e.g., user device(s) 105). A user interface (e.g., display 105A) of the user device may display one or more prompts requesting that the user input some or all of the information (e.g., “Please enter an exchange portion and investments you would like to substitute the exchange portion.”). Responsive to the one or more prompts, the user may input some or all of the requested information (e.g., “10,000 Apple stocks for the exchange portion and 5,000 IBM stocks and 5,000 Google stocks for the investments to substitute the exchange portion.”). Upon receiving the user input, the system may store the user input in one or more databases. Additionally, or alternatively, the system may receive a portfolio identifier from the user, where the system may then user the portfolio identifier to retrieve the user's investment portfolio from the internal system and/or external systems.

In some embodiments, the method may include communicating with one or more internal systems and/or one or more external systems to receive the investment portfolio, the exchange portion, the selected investments, the time period, and/or the interval length. For example, the method may including sending a request for the investment portfolio to an investment portfolio system, which may be an internal system (e.g., server system 115) or an external system (e.g., external system(s) 110). The investment portfolio system may include one or more databases that store the investment portfolio information. Upon receiving the request, the investment portfolio system may retrieve the investment portfolio information from the one or more databases, and then send such investment portfolio information to the system. Upon receiving the investment portfolio information, the system may store the investment portfolio information in one or more databases (e.g., database 115A).

The method may include computing, by the one or more processors, original set data of the original set (e.g., investment portfolio), wherein the original set data includes a value for each of the one or more records for the interval length over the time period (Step 204). In some embodiments, computing the original set data includes computing a mean value for each record, a standard deviation value for each record, a Sharpe ratio (mean divided by the standard deviation), and/or a Sortino ratio for each record for the interval length over the time period. Computing the original set data may also include computing the price history, including dividends and splits of the original portfolio over the time period at the specified intervals. For example, the system may compute the dividends and splits of the original portfolio every week (e.g., specified interval) for the past 90 days (e.g., time period).

The method may include determining, by the one or more processors, base set data of a base set (e.g., base portfolio) of the one or more records for the interval length over the time period, wherein the base set includes the original set without the exchange portion (Step 206). For example, the base set may correspond to a base portfolio that includes the original set data (e.g., original investment portfolio), where the exchange portion has been removed from the original set. In some embodiments, the system may remove the exchange portion at a previous point in time. The system may analyze the investment portfolio at the beginning of the time period, and remove the exchange portion from the investment portfolio at the beginning time period. Additionally, or alternatively, the system may also remove the exchange portion of the investment portfolio for each interval in the time period. For example, if the time period is 90 days and the interval is 7 days, the system may analyze the investment portfolio at the beginning of the past 90 days, and then remove the exchange portion from the investment portfolio at the beginning of the past 90 days and every 7 days thereafter. By way of further example, if the original portfolio had 1,000 shares each of three companies and $10,000 in cash, and the exchange portion is $2,000, then the base portfolio may include all of the shares and $8,000 in cash. As another example, if the original portfolio had 1,000 shares each of three companies and $10,000 in cash, and the exchange portion is 1,000 shares of one of the three companies, then the base portfolio may include 1,000 shares of each of the other two companies and $10,000 in cash.

The system may first determine the base portfolio, and then the system may determine the base set data by computing the price history, including dividends and splits, of the base portfolio over the time period at the specified intervals. For example, the system may compute the dividends and splits of the base portfolio every week (e.g., specified interval) for the past 90 days (e.g., time period). The system may store the base set data in one or more databases (e.g., database 115A).

The method may include comparing, by the one or more processors, the original set and the base set to determine an exchange value (Step 208). The comparing may include comparing the original set data and the base set data by subtracting the value of the base set data from the original set data. In some embodiments, the method may further include determining the cash value of the original set data and the base set data, and then subtracting the cash value of the base set data from the original set data. For example, the shares for each of the original set data and the base set data may be converted to a cash value, and then added to the cash holdings (e.g., stored cash) of the original set data or the base set data.

The method may include determining, by the one or more processors, an updated exchange value for the selected record set (e.g., candidate investments) for the interval length over the time period (Step 210). The updated exchange value may correspond to the value of the candidate investments for the intervals over the time period. For example, the updated exchange value may correspond to the price history of a candidate investment.

In some embodiments, determining the updated exchange value may include, for each of the one or more selected records, computing a mean value for each selected record (e.g., candidate investment), a standard deviation value for each selected record, and a Sharpe ratio for each selected record over the time period for the interval length. Additionally, or alternatively, in some embodiments, determining the updated exchange value may include computing a Sortino ratio for each of the one or more selected records.

The method may include updating, by the one or more processors, the base set and the base set data to include the selected record set and the updated exchange value (Step 212). For example, the base portfolio may be updated to include the candidate investments and the updated exchange value that corresponds to the candidate investments. In some embodiments, the method may further include storing, by the one or more processors, the base set data in a database (e.g., database 115A), wherein the base set data includes a unique record identifier the corresponding updated exchange value for each record. For example, after updating the base set to include the selected record set, the base set data may be updated to include a unique record identifier for each of the selected records, as well as the updated exchange value.

As discussed above, in some embodiments, the user may wish for one or more candidate investments to be analyzed separately (or together) in conjunction with the base portfolio. For example, the user may wish for the base portfolio and stocks for a technology company to be analyzed, and then for the base portfolio and stocks for an oil company to be analyzed. That way, the user may be able to see a visualization of the comparison between two or more potential investments. In such embodiments, each separate analysis of the candidate investment(s) with the base portfolio may be stored separately as updated base set data in the database.

The updating may include storing the updated exchange value and the selected record set (e.g., candidate investment identifier) in one or more databases. For example, the method may include beginning with an empty list of outputs. The method may further include computing the price history, including the dividends and splits, for each investment in the candidate set of investments over the time period for each interval. The method may further include adding the price history to the price history of the base set (e.g., base portfolio) to create a price history for a candidate portfolio. The candidate portfolio may correspond to the base portfolio that has been modified by swapping the start time value for the exchange portion for the same value worth of the candidate investment. The method may further include appending an identifier for each of the candidate set of investments to the price history to the list of outputs, and then storing and/or displaying the list of outputs. For example, the list of outputs may be stored in the database.

For example, 90 days ago, the original portfolio may have had 1,000 shares each of three companies and $10,000 in cash, and the exchange portion may correspond to 1,000 shares of one of the three companies, where the base portfolio may include 1,000 shares of each of the other two companies and $10,000 in cash. The candidate investment may correspond to a technology company. The system may determine the candidate investment amount by analyzing the value of the 1,000 shares of one of the companies at 90 days ago, and then converting the value of the original shares to determine the number of technology shares in the technology company that may be purchased with the value of the original shares. The number of shares in the technology company may then be added to the base portfolio to create the candidate portfolio. A price history for the candidate portfolio may be created by computing the mean, standard deviation, Sharpe ratio, and/or the Sortino ratio for the number of shares in the technology company over the time period for each interval. The computed values may then be appended to the values of the base portfolio and stored with corresponding identifiers in one or more databases.

In some embodiments, the method may include sorting the updated exchange values and the corresponding selected records in the database. For example, the system sort the updated exchange values by the Sharpe ratio and/or the Sortino ratio of the selected records. Additionally, the sorting may include retaining a subset of the updated exchange values and the corresponding selected records in the database, where the subset may correspond to the selected record(s) that have the highest Sharpe ratio and/or the Sortino ratio.

For example, in some embodiments, the method may include receiving, by the one or more processors, a final record value from the user. The method may further include selecting, by the one or more processors, a subset of the one or more selected records based on the final record value from the user. For example, the user may input the final record value when inputting other data, such as the original set, the exchange portion, the selected record set, the time period, and/or the interval length. The final record value may correspond to the number of candidate portfolio analyses that the user would like displayed on the device. For example, the selected record set may include ten different candidate investments that the user would like the system to analyze. The user may input a final record value of three, where the user only wants the top three candidate investments (e.g., the top three investments with the best return values) displayed on the device.

The method may include displaying, by the one or more processors, at least one model of the original set data and the updated base set data for each candidate investment on a user interface of the user device (Step 214). The model may include a graph, chart, scatter plot, and the like, that visually displays the original set data and the updated base set data for each selected record (e.g., candidate investment).

In some embodiments, the method may include displaying, by the one or more processors, the original set data and the updated base set data that corresponds to the subset of selected records on the display of the user device. For example, the system may display at least one model that visually indicates the original set data and the updated base set data that corresponds to the subset of selected records. In some embodiments, the system may automatically select the subset of selected records for display.

In some embodiments, the user may select one of the candidate investments displayed on the device. In response to receiving the selection, the system may display an option for the user to exchange the selected candidate investment for an exchange portion. If the user selects the option and indicates the exchange portion, the system may iterate through Steps 202-212 with the updated candidate investment and the updated exchange portion.

In some embodiments, the device may also display the exchange portion, where the user may select the displayed exchange portion and update the exchange portion. In response to receiving the updated exchange portion, the system may iterate through Steps 202-212 with the updated exchange portion.

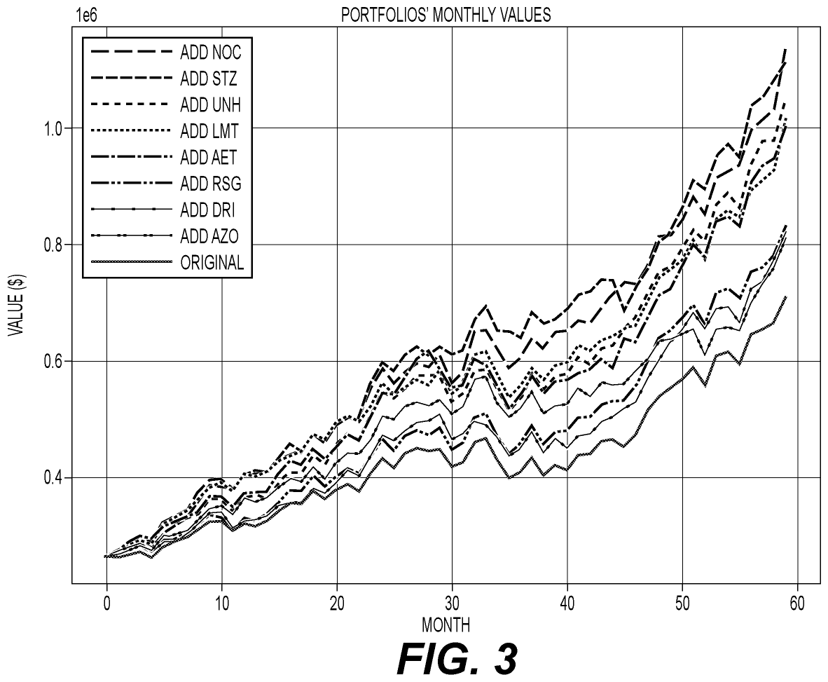

FIGS. 3-5 show exemplary models, according to one or more embodiments. For example, FIG. 3 depicts an exemplary model that illustrates a candidate portfolio's monthly values, according to one or more embodiments. The model may include a chart with the monthly values of the original portfolio and different candidate investments (e.g., “add NOC,” “add STZ”). The model may indicate the different data using different colors, line types, and the like. Additionally, for example, the model may indicate the original set data and the updated base set data as a time series, where the price histories are output on the display.

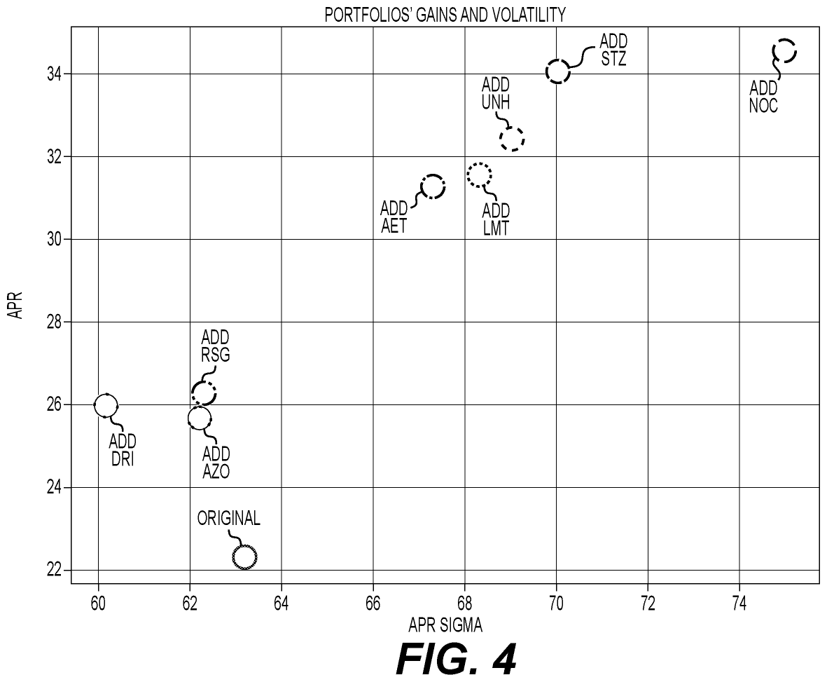

FIG. 4 depicts an exemplary model that illustrates an analysis of a candidate portfolio's gains and volatility, according to one or more embodiments. The model may include a scatter plot of the portfolio's gains and volatility. The scatter plot illustrates the standard deviation of the original portfolio and different candidate investments (e.g., “add NOC,” “add STZ”). The scatter plot may use different colors to illustrate the differences in portfolios.

FIG. 5 depicts an exemplary model that illustrates an analysis of a candidate portfolio's gains, volatility, and Sharpe ratio, according to one or more embodiments. The model may also include annotations of the candidate investments. For example, the system may indicate the candidate investments that have more gains, but with more risk. The system may also indicate the candidate investments that have more gains, but with less risk. Additionally, the system may indicate the Sharpe ratio to the user.

Although FIG. 2 shows example blocks of exemplary method 200, in some implementations, the exemplary method 200 may include additional blocks, fewer blocks, different blocks, or differently arranged blocks than those depicted in FIG. 2 Additionally, or alternatively, two or more of the blocks of the exemplary method 200 may be performed in parallel.

### Exemplary Computer System

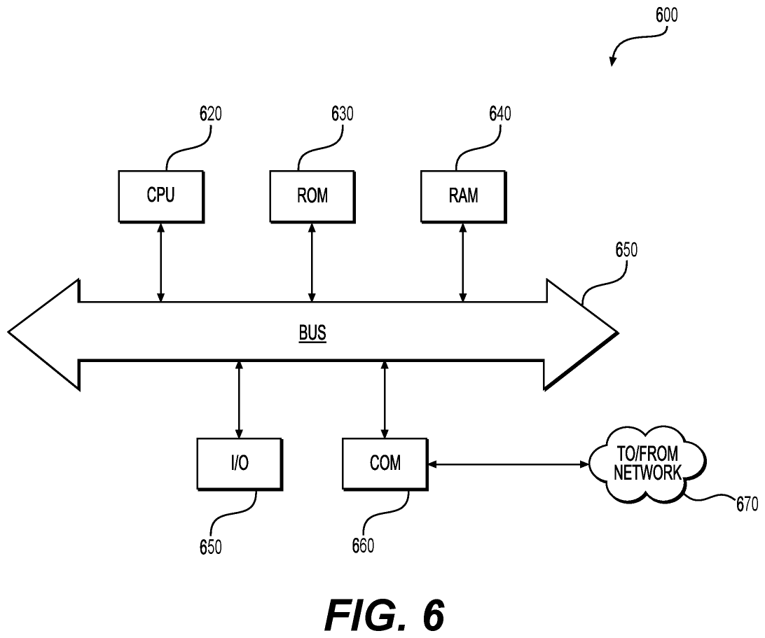

FIG. 6 illustrates a high-level functional block diagram of an exemplary computer system 600, in which embodiments of the present disclosure, or portions thereof, may be implemented, e.g., as computer-readable code. For example, each of the exemplary devices and systems described above with respect to FIG. 6 can be implemented in computer system 600 using hardware, software, firmware, tangible computer readable media having instructions stored thereon, or a combination thereof and may be implemented in one or more computer systems or other processing systems. Hardware, software, or any combination of such may embody any of the modules and components in FIG. 6, as described above.

If programmable logic is used, such logic may execute on a commercially available processing platform or a special purpose device. One of ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device.

For instance, at least one processor device and a memory may be used to implement the above-described embodiments. A processor device may be a single processor, a plurality of processors, or combinations thereof. Processor devices may have one or more processor “cores.”

Various embodiments of the present disclosure, as described above in the examples of FIGS. 1-5 may be implemented using computer system 600, shown in FIG. 6. After reading this description, it will become apparent to a person skilled in the relevant art how to implement embodiments of the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

FIG. 6 provides a functional block diagram illustration of general purpose computer hardware platforms. FIG. 6 illustrates a network or host computer platform 600, as may typically be used to implement a server, such as user device(s) 105, external system(s) 110, and server system 115. It is believed that those skilled in the art are familiar with the structure, programming, and general operation of such computer equipment and, as a result, the drawings should be self-explanatory.

A platform for a server or the like 600, for example, may include a data communication interface for packet data communication 660. The platform may also include a central processing unit (CPU) 620, in the form of one or more processors, for executing program instructions. The platform typically includes an internal communication bus 610, program storage, and data storage for various data files to be processed and/or communicated by the platform such as ROM 630 and RAM 640, although the computer platform 600 often receives programming and data via network communications 670. The hardware elements, operating systems, and programming languages of such equipment are conventional in nature, and it is presumed that those skilled in the art are adequately familiar therewith. The computer platform 600 also may include input and output ports 650 to connect with input and output devices such as keyboards, mice, touchscreens, monitors, displays, etc. Of course, the various computer platform functions may be implemented in a distributed fashion on a number of similar platforms, to distribute the processing load. Alternatively, the computer platforms may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as those used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

It would also be apparent to one of skill in the relevant art that the present disclosure, as described herein, can be implemented in many different embodiments of software, hardware, firmware, and/or the entities illustrated in the figures. Any actual software code with the specialized control of hardware to implement embodiments is not limiting of the detailed description. Thus, the operational behavior of embodiments will be described with the understanding that modifications and variations of the embodiments are possible, given the level of detail presented herein.

It is to be understood that both the foregoing general description and the following detailed description are exemplary and explanatory only and are not restrictive of the disclosed embodiments, as claimed.

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A computer-implemented method for providing a value analysis, the computer-implemented method comprising:
receiving, by one or more processors, an original set of one or more records, an exchange portion of the original set, a selected record set of one or more selected records, a time period, and an interval length from a user via a user device;
computing, by the one or more processors, original set data of the original set, wherein the original set data includes a value for each of the one or more records for the interval length over the time period;
determining, by the one or more processors, base set data for a base set of the one or more records for the interval length over the time period, wherein the base set includes the original set without the exchange portion;
comparing, by the one or more processors, the original set and the base set to determine an exchange value;
determining, by the one or more processors, an updated exchange value for the selected record set for the interval length over the time period;
updating, by the one or more processors, the base set and the base set data to include the selected record set and the updated exchange value; and
displaying, by the one or more processors, at least one model of the original set data and the updated base set data for each selected record of the selected record set on a user interface of the user device.

2. The computer-implemented method of claim 1, wherein determining the updated exchange value includes, for each of the one or more selected records, computing a mean value for each selected record, a standard deviation value for each selected record, and a Sharpe ratio for each selected record over the time period for the interval length.

3. The computer-implemented method of claim 1, wherein computing the original set data includes computing a mean value for each record, a standard deviation value for each record, and a Sharpe ratio for each record for the interval length over the time period.

4. The computer-implemented method of claim 1, the computer-implemented method further comprising:
receiving, by the one or more processors, a final record value from the user.

5. The computer-implemented method of claim 4, the computer-implemented method further comprising:
selecting, by the one or more processors, a subset of the one or more selected records based on the final record value from the user.

6. The computer-implemented method of claim 5, the computer-implemented method further comprising:
displaying, by the one or more processors, the original set data and the updated base set data that corresponds to the subset of the one or more selected records on the user interface of the user device.

7. The computer-implemented method of claim 1, wherein the original set data of one or more records includes a unique record identifier and a record amount for each of the one or more records.

8. The computer-implemented method of claim 1, wherein the selected record set includes a default set of selected records.

9. The computer-implemented method of claim 1, wherein the time period includes a default time period, and wherein the interval length includes a default interval length.

10. The computer-implemented method of claim 1, the computer-implemented method comprising:
storing, by the one or more processors, the base set data in a database, wherein the base set data includes a unique record identifier and the corresponding updated exchange value for each record.

11. A computer system for providing a value analysis, the computer system comprising:
a memory having processor-readable instructions stored therein; and
one or more processors configured to access the memory and execute the processor-readable instructions, which when executed by the one or more processors configures the one or more processors to perform a plurality of functions, including functions for:
receiving an original set of one or more records, an exchange portion of the original set, a selected record set of one or more selected records, a time period, and an interval length from a user via a user device;
computing original set data of the original set, wherein the original set data includes a value for each of the one or more records for the interval length over the time period;
determining base set data for a base set of the one or more records for the interval length over the time period, wherein the base set includes the original set without the exchange portion;
comparing the original set and the base set to determine an exchange value;
determining an updated exchange value for the selected record set for the interval length over the time period;
updating the base set and the base set data to include the selected record set and the updated exchange value; and
displaying at least one model of the original set data and the updated base set data for each selected record of the selected record set on a user interface of the user device.

12. The computer system of claim 11, wherein determining the updated exchange value includes, for each of the one or more selected records, computing a mean value for each selected record, a standard deviation value for each selected record, and a Sharpe ratio for each selected record over the time period for the interval length.

13. The computer system of claim 11, wherein computing the original set data includes computing a mean value for each record, a standard deviation value for each record, and a Sharpe ratio for each record for the interval length over the time period.

14. The computer system of claim 11, the functions further comprising:
receiving a final record value from the user.

15. The computer system of claim 14, the functions further comprising:
selecting, a subset of the one or more selected records based on the final record value from the user.

16. The computer system of claim 15, the functions further comprising:
displaying the original set data and the updated base set data that corresponds to the subset of the one or more selected records on the user interface of the user device.

17. A non-transitory computer-readable medium containing instructions for providing a value analysis, the instructions comprising:
receiving an original set of one or more records, an exchange portion of the original set, a selected record set of one or more selected records, a time period, and an interval length from a user via a user device;
computing original set data of the original set, wherein the original set data includes a value for each of the one or more records for the interval length over the time period;
determining base set data for a base set of the one or more records for the interval length over the time period, wherein the base set includes the original set without the exchange portion;
comparing the original set and the base set to determine an exchange value;
determining an updated exchange value for the selected record set for the interval length over the time period;
updating the base set and the base set data to include the selected record set and the updated exchange value; and
displaying at least one model of the original set data and the updated base set data for each selected record of the selected record set on a user interface of the user device.

18. The non-transitory computer-readable medium of claim 17, wherein the original set data of one or more records includes a unique record identifier and a record amount for each of the one or more records.

19. The non-transitory computer-readable medium of claim 17, wherein the selected record set includes a default set of selected records.

20. The non-transitory computer-readable medium of claim 17, wherein the time period includes a default time period, and wherein the interval length includes a default interval length.
